(19) United States
(12) Patent Application Publication
(10) Pub. No.: US 2026/0311704 A1
(43) Pub. Date: Oct. 8, 2026

(54) Onboard Vehicle Announcement System

(71) Applicant: The Boeing Company, Arlington, VA (US)

(72) Inventors: Amy Elizabeth Goodell, Seattle, WA (US); Ashley Marie Gordon Badger, Seattle, WA (US); Julia Kaitlyn Kjenstad, Tacoma, WA (US); Kyle McLaren Hadley, Kenmore, WA (US); Ethan Carl Owyang, Bothell, WA (US)

(21) Appl. No.: 19/635,949

(22) Filed: Apr. 1, 2026

Related U.S. Application Data
(60) Provisional application No. 63/784,634, filed on Apr. 7, 2025.

(51) Int. Cl. G10L 15/26; G06F 40/58; G10L 15/30

(52) U.S. Cl. CPC G10L 15/26; G06F 40/58; G10L 15/30

(57) ABSTRACT

Systems and methods of transcribing audible announcements that are made live by persons onboard a vehicle through an onboard announcement system. The corresponding text of the announcements are presented to the passenger in one or more different manners. The processing of the corresponding text can be performed in one or more different manners including through onboard processing, offboard processing, and/or through a portable electronic device of the passenger.

### RELATED APPLICATIONS

This application claims the benefit of U.S. Provisional Application No. 63/784,634, filed on Apr. 7, 2025, and which is hereby incorporated by reference in its entirety.

### TECHNOLOGICAL FIELD

The present disclosure relates generally to the field of communications, more specifically, to communicating with passengers that are riding on a vehicle through text content that corresponds to audio announcement.

### BACKGROUND

Passengers on vehicles often receive information through audible announcements. For example, passengers on an aircraft receive information through listening to announcements made over an announcement system. The announcements can include various details including but not limited to instructions for takeoff and landing procedures, status reports about current location and time of arrival, and information about the arrival gate and terminal. Other examples include emergency instructions regarding procedures if an event were to occur to the vehicle.

Announcements made audibly through the announcement system can sometimes be incomprehensible. In some examples the passengers are deaf and/or hard of hearing. In other examples, the announcements are difficult to hear because of one or more issues such as but not limited to inferior audio quality, high levels of background noise, language barriers, and passenger headphone usage.

In some examples, close captioning is provided on display screens for pre-recorded announcement videos. However, there are many live announcements made over the public address system that do not include close captioning.

### SUMMARY

One aspect is directed to a method of displaying text of a live audio announcement to a passenger on a vehicle. The method comprises: receiving the audio content of the live audio announcement that is presented by personnel that are onboard the vehicle; converting the audio content to text content that corresponds to the audio content; playing the audio content onboard the vehicle through a speaker to the passenger; and displaying the text content onboard the vehicle on a display device to the passenger.

In another aspect, the method further comprises receiving the audio content through a microphone onboard the vehicle.

In another aspect, the method further comprises simultaneously playing the audio content through the speaker and displaying the text content on the display device.

In another aspect, the method further comprises converting the audio content to the text content onboard the vehicle.

In another aspect, the method further comprises transmitting the audio content to a remote node offboard of the vehicle, receiving onboard the vehicle the text content from the remote node, and displaying onboard the vehicle the text content that is received from the remote node.

In another aspect, converting the audio content to the text content comprises translating the audio content from a first language to the text content in one or more different languages.

In another aspect, converting the audio content to the text content comprises formatting the text content to a predetermined format to enable being displayed on the display device.

In another aspect, the method further comprises processing the audio content with a computing device onboard the vehicle and playing the audio content through the speaker and converting the audio content to the text content on a portable electronic device of the passenger.

In another aspect, the method further comprises receiving the audio content at a portable electronic device of the passenger, transmitting the audio content from the portable electronic device to a remote node offboard the vehicle, and after transmitting the audio content, receiving the text content at the portable electronic device from the remote node.

One aspect is directed to a method of displaying text of a live audio announcement to a passenger on a vehicle. The method comprises: receiving at a computing device onboard the vehicle the audio content that is input through a microphone that is onboard the vehicle; presenting the audio content to the passenger onboard the vehicle; generating text content that corresponds to the audio content; and displaying the text content on a display device onboard the vehicle to the passenger.

In another aspect, presenting the audio content comprises transmitting the audio content to a portable electronic device and playing the audio content through the speaker of the portable electronic device.

In another aspect, generating the text content comprises generating the text content onboard the vehicle.

In another aspect, generating the text content comprises generating the text content at a portable electronic device of the passenger.

In another aspect, generating the text content occurs offboard the vehicle.

In another aspect, the method further comprises transmitting the audio content from a portable electronic device of the passenger to a remote node that is offboard the vehicle with the remote node generating the text content.

In another aspect, the method further comprises receiving a registration request for the portable electronic device prior to transmitting the audio content.

In another aspect, the method further comprises delaying presenting the audio content and simultaneously displaying the audio content and the text content.

One aspect is directed to a computing device to display content on a vehicle with the computing device comprising: processing circuitry; and memory circuitry that stores programming instructions that, when executed by the processing circuitry, configures the computing device to: receive the audio content that is presented by personnel that are onboard the vehicle; convert the audio content to text content that corresponds to the audio content; and display the text content on a display device to the passenger.

In another aspect, communication circuitry is configured to transmit the audio content to a remote node offboard the vehicle and receive the text content from the remote node.

In another aspect, the processing circuitry and the memory circuitry are located on the vehicle.

One aspect is directed to a method of displaying text of an audio announcement to a passenger on a vehicle. The method comprises: receiving the audio content that is presented by personnel that are onboard the vehicle; converting the audio content to text content that corresponds to the audio content; and displaying the text content on a display device to the passenger.

In another aspect, the method further comprises receiving the audio content through a microphone onboard the vehicle.

In another aspect, the method further comprises recording the audio content prior to playing the audio content to the vehicle.

In another aspect, the method further comprises converting the audio content to the text content onboard the vehicle.

In another aspect, the method further comprises transmitting the audio content to a remote node offboard the vehicle and receiving the text content from the remote node.

In another aspect, converting the audio content to the text content comprises translating the audio content from a first language to the text content in a different second language.

In another aspect, converting the audio content to the text content comprises formatting the text content to a predetermined format to enable being displayed on the display device.

In another aspect, the method further comprises processing the audio content in a first process when the audio content is live content and processing the audio content in a different second process when the audio content is pre-recorded content.

In another aspect, the method further comprises playing the audio content through speakers onboard the vehicle.

In another aspect, the method further comprises simultaneously playing the audio content through the speakers and displaying the text content on the display devices.

In another aspect, the method further comprises converting the audio content to the text content on a portable electronic device of the passenger.

In another aspect, the method further comprises receiving the audio content at a personnel electronic device of the passenger and transmitting the audio content to a remote node offboard the vehicle.

One aspect is directed to a non-transitory computer readable medium storing a computer program product for controlling a host computer with the computer program product comprising software instructions that, when run on processing circuitry of the host computer, cause the host computer to: receive audio content that is presented by personnel that are onboard an aircraft; convert the audio content to text content that corresponds to the audio content; and display the text content on a display device to the passenger.

One aspect is directed to a computing device to display content on a vehicle with the computing device comprising: processing circuitry; and memory circuitry that stores programming instructions that, when executed by the processing circuitry, configures the computing device to: receive the audio content that is presented by personnel that are onboard the aircraft; convert the audio content to text content that corresponds to the audio content; and display the text content on a display device to the passenger.

In another aspect, the processing circuitry is configured to transmit the audio content to a remote node offboard the vehicle and receive the text content from the remote node.

In another aspect, the processing circuitry and the memory circuitry are located on the vehicle.

In another aspect, the text content is predetermined and stored at the memory circuitry.

In another aspect, onboard communication circuitry is configured to convert the audio content to the text content onboard the aircraft.

In another aspect, offboard communication circuitry is configured to transmit the audio content to a remote node and to receive the text content from the remote node.

One aspect is directed to a method of broadcasting content to passengers on a vehicle with the method comprising: receiving content that is to be broadcasted; determining how to broadcast the content; and broadcasting the content either with audio content or without audio content.

In another aspect, the method further comprises receiving the content from an attendant input panel positioned in a cabin area in the vehicle.

In another aspect, the method further comprises receiving the content from a crew device that is operated by a crew member of the vehicle.

In another aspect, the method further comprises broadcasting the content with the audio content when the content is received through a microphone.

In another aspect, the method further comprises broadcasting the content with the audio content when the content is received from an attendant input panel positioned in a cabin area in the vehicle.

In another aspect, the method further comprises broadcasting the content with audio content when the content is a live announcement.

In another aspect, the method further comprises broadcasting the content just as text content when broadcasting without the audio content.

One aspect is directed to a computing device to broadcast content on a vehicle with the computing device comprising processing circuitry and memory circuitry that stores programming instructions that, when executed by the processing circuitry, configures the computing device to: receive content that is to be broadcasted; and determine whether to broadcast the content with or without audio content.

In another aspect, the processing circuity is further configured to broadcast the content either with audio content or without audio content.

In another aspect, the processing circuitry and the memory circuitry are both located on the vehicle.

In another aspect, text content is displayed on display devices with the text content being stored at the memory circuitry.

One aspect is directed to a non-transitory computer readable medium storing a computer program product for controlling a host computer with the computer program product comprising software instructions that, when run on processing circuitry of the host computer, cause the host computer to: receive content that is to be broadcasted; determine how to broadcast the content; and broadcast the content either with audio content or without audio content.

One aspect is directed to a method of communicating with a passenger on a vehicle with the method comprising: receiving a message through a messaging application from a passenger through a PED of the passenger; and displaying content of the message on a display device at an attendant module onboard the vehicle.

In another aspect, the method further comprises forwarding an app to the PED that enables messaging communications.

In another aspect, the method further comprises transmitting a response message from the display device to the PED.

In another aspect, the method further comprises receiving the message while the vehicle is moving.

In another aspect, the vehicle is an aircraft and further comprising receiving the message during flight.

One aspect is directed to a computing device to broadcast content on a vehicle with the computing device comprising: processing circuitry and memory circuitry that stores programming instructions that, when executed by the processing circuitry, configures the computing device to: receive a message through a message application from a passenger through a PED of the passenger; and display content of the message at a display device at an attendant module onboard the vehicle.

One aspect is directed to a non-transitory computer readable medium storing a computer program product for controlling a host computer with the computer program product comprising software instructions that, when run on processing circuitry of the host computer, cause the host computer to: receive a message through a messaging application from a passenger through a PED of the passenger; and display content of the message on a display device at an attendant module onboard the vehicle.

The features, functions and advantages that have been discussed in these claims can be achieved independently in various aspects or may be combined in yet other aspects, further details of which can be seen with reference to the description and the drawings.

### BRIEF DESCRIPTION OF THE DRAWINGS

FIG. 1 is an isometric diagram of a vehicle.

FIG. 2 is a schematic section view taken along line II-II of FIG. 1.

FIG. 3 is a schematic diagram of an onboard announcement system.

FIG. 4 is a flowchart diagram of a method of generating and providing corresponding text for an audio input.

FIG. 5 is a diagram of components configured to convert the live audio content to text.

FIG. 6 is a schematic flow diagram of the processing to generate the text context in response to receiving audio.

FIG. 7 is a schematic diagram of an onboard announcement system that provides the corresponding text for live audio.

FIG. 8 is a schematic flow diagram of a process to enable a passenger to receive corresponding text with a live audio announcement.

FIG. 9 is a schematic flow diagram of a process of generating corresponding text at a remote node that is offboard the vehicle.

FIG. 10 is a schematic flow diagram of a process of generating corresponding text at a portable electronic device (PED) of a passenger.

FIG. 11 is a schematic flow diagram of a process of generating corresponding text through a PED that captures the audio content and transmits the audio content for offboard processing.

FIG. 12 is a flowchart diagram of a method of presenting content to passengers in a vehicle.

FIG. 13 is a schematic diagram of a computing device that communicates with a PED and an attendant panel.

FIG. 14 is a flowchart diagram of a method of communicating with a passenger on an a vehicle.

FIG. 15 is a schematic diagram of a computing device.

FIG. 16 is a schematic diagram of a PED.

FIG. 17 is a schematic diagram of a remote node.

### DETAILED DESCRIPTION

The present application is directed to systems and methods of transcribing audible announcements that are made live by persons onboard a vehicle through an onboard announcement system. The corresponding text of the announcements are presented to the passenger in one or more different manners. The processing of the corresponding text can be performed in one or more different manners including through onboard processing, offboard processing, and/or through a portable electronic device of the passenger.

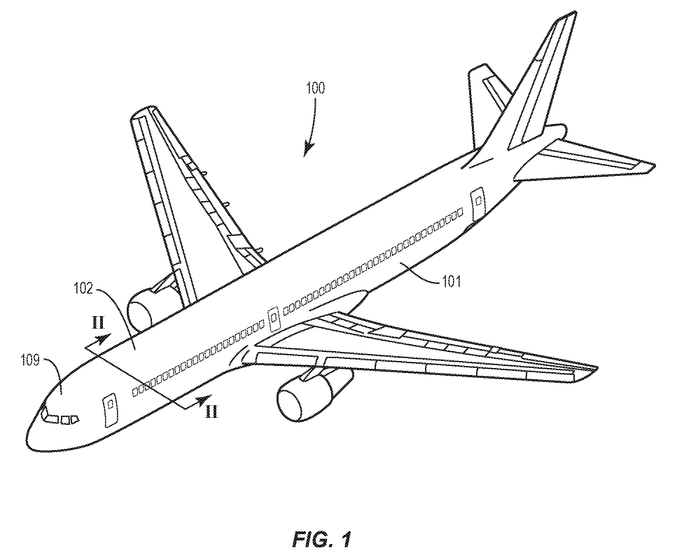

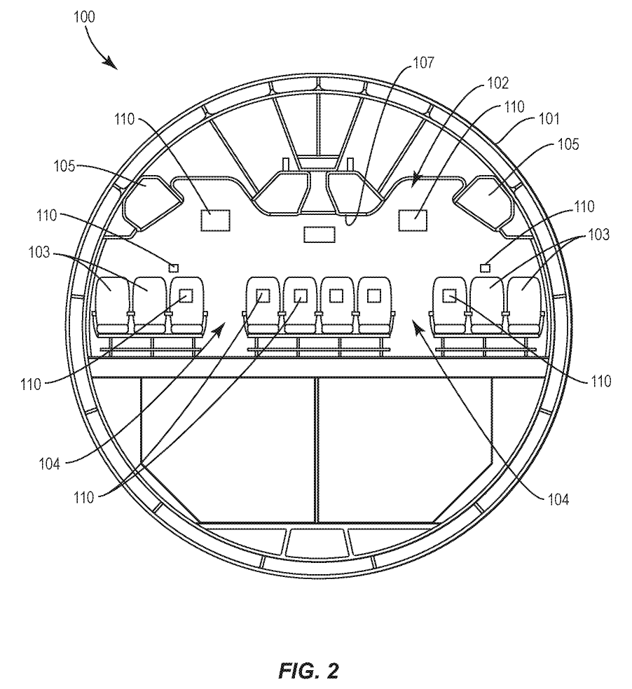

FIGS. 1 and 2 illustrate one example of a vehicle, namely a commercial aircraft 100. The aircraft 100 includes a fuselage 101 configured to hold passengers and cargo. The fuselage 101 includes a cabin area 102 with various components configured to accommodate passengers during flight. The components can include seats 103 that are spread across a width of the fuselage 101 and separated by one or more aisles 104. Overhead storage bins 105 are positioned at the ceiling 107 over the seats 103 and are configured to hold personal items of the passengers. A flight deck 109 is positioned at the front of the fuselage 101 and includes flight equipment to enable the flight crew to operate the aircraft 100.

An output system provides for communicating information to the passengers. The output system includes components 110 that are mounted at one or more positions in the cabin area 102 to convey information to the passengers. Examples of components 110 include a display screen configured to output visual information and speakers to output sound to the passengers. In some examples, the components 110 include integrated display screens and speakers. In other examples, the display screens and speakers are separate. Examples of display screens include various technologies, such as but not limited to CRT, LED, LCD, and OLED screens.

In some examples, the components 110 are mounted on one or more of the seats 103 to provide entertainment and connectivity services to the passengers. In one specific example, the components 110 are mounted on the back of the seats 103 to provide services to the passenger that is seated directly behind in the next row. Components 110 can also be mounted at other locations, such as on monuments that are positioned in the cabin area 102, within lavatories, at entryways into the cabin area 102, and on the storage bins 105 and/or ceiling 107 and are configured to drop down during use to be visible to the passengers.

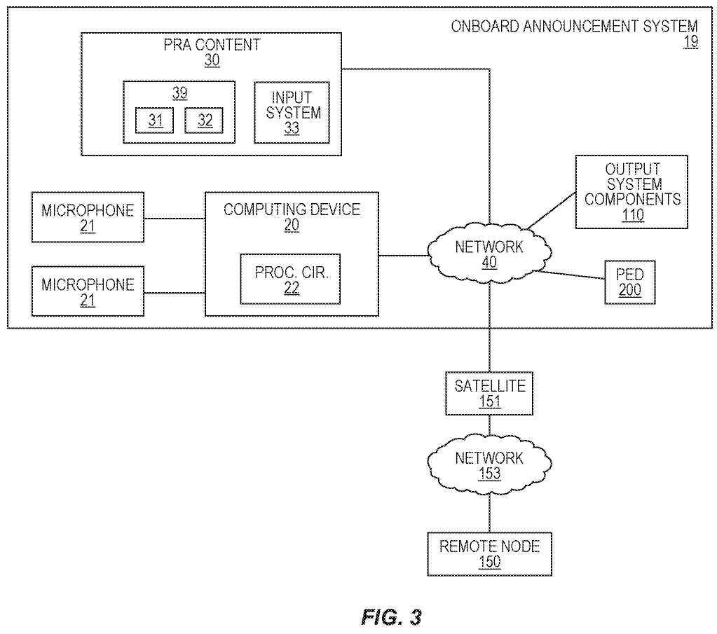

FIG. 3 illustrates an onboard announcement system 19 in which visual and audio content is provided to a passenger on the aircraft 100. FIG. 3 includes the onboard announcement system 19 providing content to a single passenger, although it is understood that the content is provided to multiple passengers on the aircraft 100. A computing device 20 receives live audio from one or more microphones 21. In some examples, one or more of the microphones 21 is positioned in the flight deck 109 to enable announcements to be made by the flight crew. One or more microphones 21 are also positioned in the cabin area 102 to enable announcements to be made by the cabin crew. The on-board computing device 20 includes processing circuitry 22 configured to process the audio input to enable the audio to be played in real time to the passenger. The audio signals are configured to be audibly played through the one or more speakers. The audio signals are further configured to be played through a portable electronic device (PED) 200 that is registered by the passenger. The processing circuitry 22 is further configured to convert the audio input into corresponding text that is displayed to the passenger through the components 110 of the output system. The text is displayed on one or more components 110 of the output system and/or the PED 200.

An attendant panel 30 is located in the cabin area 102 and enables the cabin crew to play pre-recorded content 39 to the passenger. The pre-recorded content 39 includes audio content 31 that includes one or more of videos and audible messages. The pre-recorded content 39 also includes text content 32 that corresponds to the audio content 31. In some examples, the pre-recorded content 39 include information that are repeated during each flight. Examples include but are not limited to pre-flight instructions, advertisements, and landing instructions.

The attendant panel 30 can also store various other videos and/ or audio that include but are not limited to movies, television shows, music, podcasts, news, and various sporting events. In some examples, the attendant panel 30 is configured to provide videos of live events to the passengers.

The attendant panel 30 includes an input device 33 (e.g., touch screen display, keyboard) to enable the cabin crew to operate and play the various content to the passenger.

The text and audio content from the computing device 20 and the attendant panel 30 is provided to the various output devices through an on-board network 40. The network 40 is configured for wireless and/or wired communications. The network 40 can include one or more of a wireless network, a wired network or any combination of wireless network and wired network. For example, the network 40 can include one or more of a fiber optics network, a passive optical network, a cable network, an Internet network, a satellite network, a wireless local area network (LAN), Wi-Fi, and/or the like. In some examples, wireless access points are positioned around the cabin area 102 to enable connection by one or more of the output devices.

The passenger PED 200 can be registered to enable the passenger to view and hear the content. Examples of the PED 200 include but are not limited to cellular phones, laptop computers, tablets, e-readers, gaming devices, and smart watches. The PED 200 are configured to provide passengers with visual and audio content that are distributed through the system. The passenger registers the PED 200 at some point prior to or during the flight to enable the passenger to log into the network and receive the content.

The live content entered through the microphones 21 and the pre-recorded content 39 is distributed to the passenger in both audio and text format. This enables the passenger to visually see the information in the event of impaired hearing. The text content is intended to benefit a variety of different types of passengers. One type of passenger includes deaf and/or hard of hearing. Another passenger type is those who are unable to hear the audio content for one or more reasons including but not limited to inferior audio quality, high levels of background noise, language barriers, and passenger headphone usage.

As further illustrated in FIG. 3, the aircraft 100 is configured to communicate through the network 40 with a remote node 150 that is located offboard from the aircraft 100. The communications between the aircraft 100 and the remote node 150 occurs through one or more of a satellite 151, cellular network, and network 153. In some examples, the remote node 150 is configured to process and convert the live audio to text that is transmitted to the aircraft 100 for display to the passenger. In some examples, the PED 200 is further configured to communicate with the remote node 150.

The onboard announcement system 19 is configured to transcribe live audible announcements that are made onboard the aircraft 100 through the microphones 21. The corresponding text of the live announcements are presented to the passenger in one or more different manners. The processing of the corresponding text can be performed in one or more different manners including through onboard processing, offboard processing, and/or through a portable electronic device of the passenger.

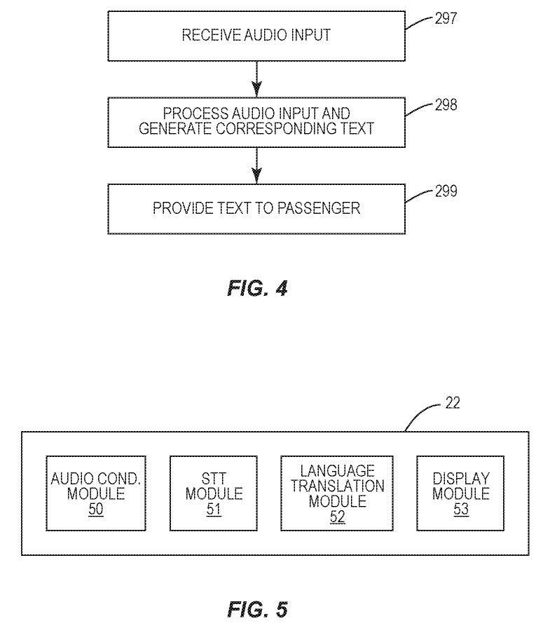

FIG. 4 illustrates an overview of the text content functionality. The computing device 20 receives the live audio input (block 297). The audio input is processed to generate the corresponding text (block 298). The processing can occur onboard or offboard and can be accomplished by various different components. The text is then displayed to the passenger through one or more of the output devices (block 299).

In some examples, the text processing generates the text in a default language. The default language can correspond to the departure location or arrival location of the aircraft 100. In some examples, the default language is always the same regardless of the location of the aircraft 100 (e.g., English, Spanish). In other examples, the text processing enables the passenger to select the language. The passenger makes the selection through one or more of the components 110 and PED 200. In one example, the component includes a display screen with one or more of touch screen capability or input device to enable the passenger to make a language selection. In other examples, the passenger makes the language selection when they purchase a ticket or when they check in for the flight.

FIG. 5 includes functional components of the processing circuitry 22 of the computing device 20 that are configured to convert the live audio content to text. The processing circuitry 22 includes an audio conditioning module 50 that applies a denoising algorithm model to remove background noise. A speech-to-text (STT) module 51 converts the audio signals to text. In some examples, this process includes applying a pre-trained speech-to-text model to convert the pre-process audio signals into text. Language translation module 52 converts the processed text into the desired language (e.g., English, Spanish, French). A display module 54 formats the text content for display to the passenger. The formatted data is then supplied to one or more of the various output devices.

The processing of the audio content is performed in a real-time manner. This ensures that important information that is audibly entered through the microphone 21 is quickly presented to the passenger.

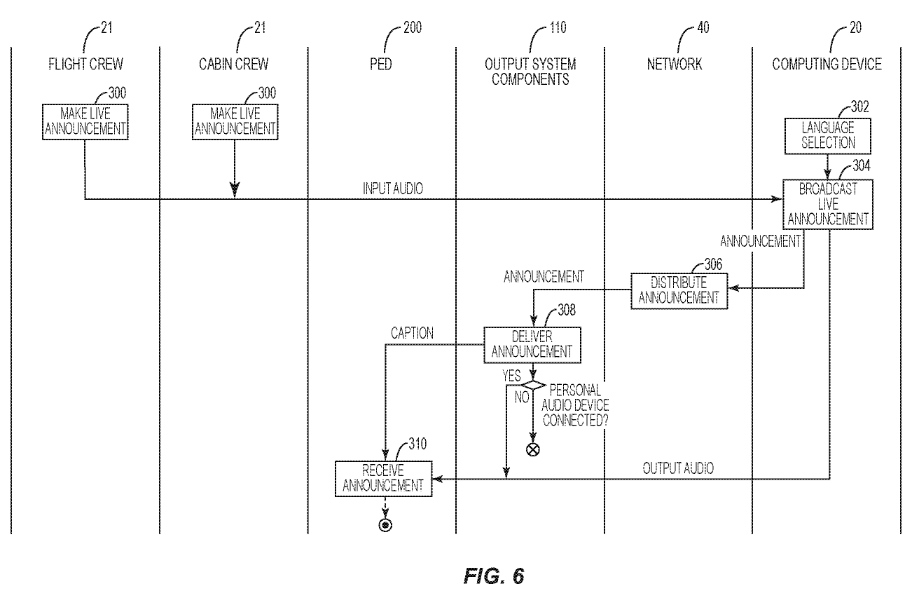

FIG. 6 illustrates a flow diagram of the processing that occurs to generate the text context in response to receiving audio. A live announcement is made by the flight crew and/or cabin crew using one or more of the microphones 21 (block 300). The audio input is transmitted to the computing device 20. In this example, the passenger has previously input their desired text language to the computing device 20 (block 302). The computing device 20 processes the audio input and generates the corresponding text (block 304). The text and audio are sent through the network 40 (block 306) to the one or more components 110 of the output system where the text and audio are output (block 308). When the passenger registers their PED 200, the audio and text are further provided to the passenger PED 200 (block 310). As further illustrated in FIG. 6, the computing device 20 sends the audio directly to the PED 200.

In some examples, the PED 200 is able to simultaneously display multiple different messages. One example is displaying the text of pre-processed transcription/translation such as from a movie or show that they are watching. In addition, the PED 200 is able to display the text of the audio announcement.

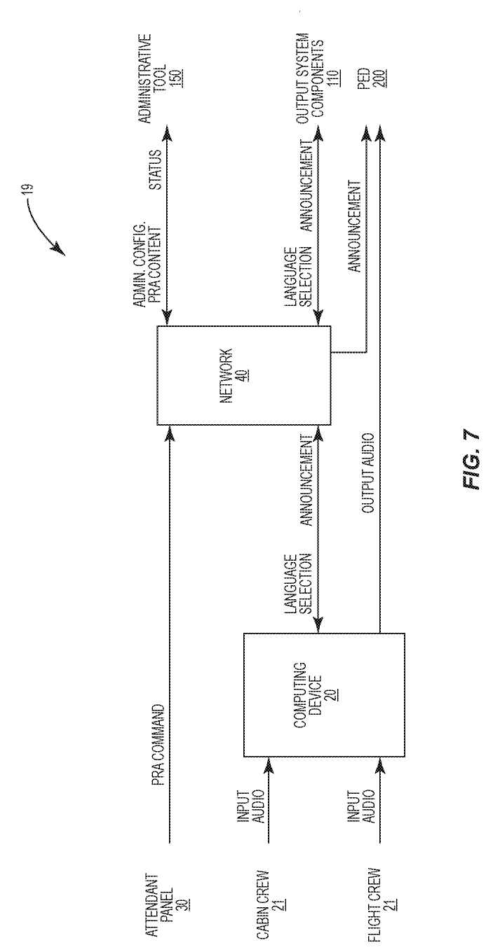

FIG. 7 illustrates a schematic diagram of the onboard announcement system 19 that provides the corresponding text for live audio. The live audio announcements are made through one or more microphones 21 and are input into the computing device 20. The computing device 20 processes the audio input and generates the corresponding text. The announcement that includes the audio and corresponding text are sent through the network 40 to the components 110 of the output system and PED 200.

As further illustrated in FIG. 7, the passenger makes a language selection through one of the components 110. The language selection is sent through the network 40 to the computing device 20 for processing to develop the corresponding text in the desired language. In some examples, a default text (e.g., English) is sent to the passenger to correspond with the audio. The default text is used unless the passenger inputs their language selection. As further illustrated in FIG. 7, the computing device 20 directly outputs the audio to the passenger portable electronic device 200. This output bypasses the onboard network 40.

Pre-recorded announcements (PRA) are input through the attendant panel 30. These announcements are distributed through the network 40 to the passenger through one or more components 110 and/or PED 200.

The onboard announcement system 19 is further configured for access by the remote node 150. In this example, the remote node 150 is an entity that manages the aircraft 100, such as an airline. The remote node 150 is able to upload and/or configure pre-recorded announcements (PRA) that are stored at the attendant panel 30. In some examples, the remote node 150 is able to access the computing device 20 to perform maintenance and/or other functions.

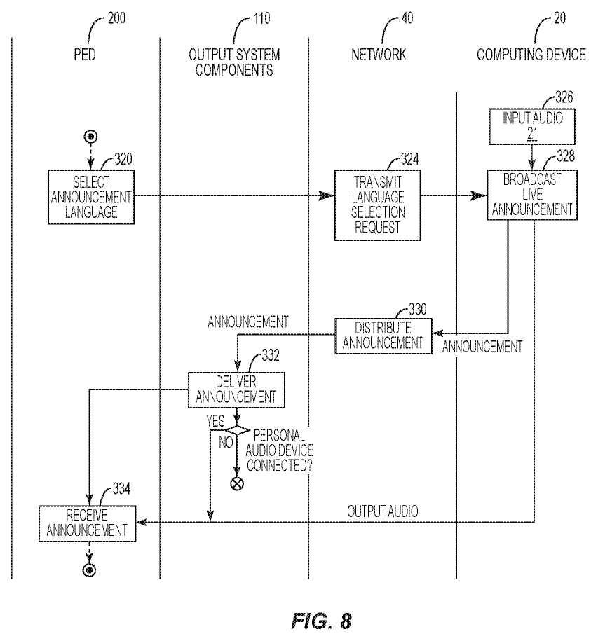

FIG. 8 illustrates an example of the process to enable a passenger to receive corresponding text with a live audio announcement. In this example, the passenger inputs a language selection through a PED 200 (block 320). The selection is forwarded through the network 40 (block 324) to the computing device 20. At some point afterwards, the computing device 20 receives live audio input (block 326). The computing device 20 processes the audio input and develops the corresponding text (block 328). The text and audio are delivered through the network (block 330) to the components 110 of the output system (block 332). If the passenger has registered their PED 200, the audio and corresponding text are further delivered to the PED 200 (block 334).

In some examples, the onboard announcement system 19 is configured to receive the audio input through the microphone 21 and generate the corresponding text. In other examples, some or all of the text processing is performed at the remote node 150 offboard the aircraft 100.

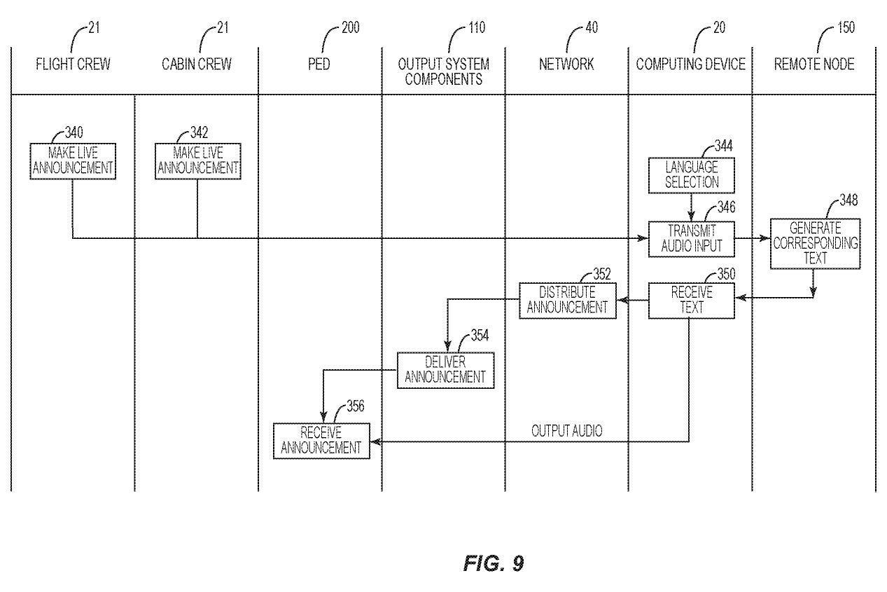

FIG. 9 illustrates a method in which the text processing is offboarded from the aircraft 100. The audio content is input through one or more microphones 21 (blocks 340, 342). The live audio is received by the computing device 20 which has also previously received a language selection (block 344) from the passenger. The audio data and the language selection are transmitted to the remote node 150 which is located offboard from the aircraft 100 (block 346). In this example, the computing device 20 is configured to communicate with the remote node 150. Additionally, or alternatively, another communication system onboard the aircraft 100 (e.g., main communication system) sends and receives the information to and from the remote node 150.

The audio information is received at the remote node 150 and is processed to generate the corresponding text (block 348). The corresponding text is transmitted from the remote node 150 back to the aircraft 100. The computing device 20 receives the corresponding text from the remote node 150 (block 350) and transmits the text with the audio through the network 40 (block 352). The audio and the corresponding text are delivered to the passenger through one or more of the components 110 of the output system and PED 200 (block 354, 356).

The remote node 150 includes processing circuitry configured to process the audio data and generate the corresponding text. The remote node 150 further includes memory circuitry for storing the necessary data and communication circuitry for sending and receiving data with the aircraft 100. In some examples, the remote node 150 is a server and/or computing device.

In some examples, the processing of the live audio to the corresponding text is performed by the passenger PED 200. The PED 200 receives the live audio and generates the corresponding text content. In some examples, the PED 200 includes a microphone that receives the audio that is played through the speakers of the output system 110. Additionally, or alternatively, the computing device 20 transmits the audio data to the PED 200 which generates the corresponding text. In some examples, the PED 200 transmits the corresponding text to the output system that displays the corresponding text on one or more components 110 (e.g., a display screen at the seat 103 of the passenger).

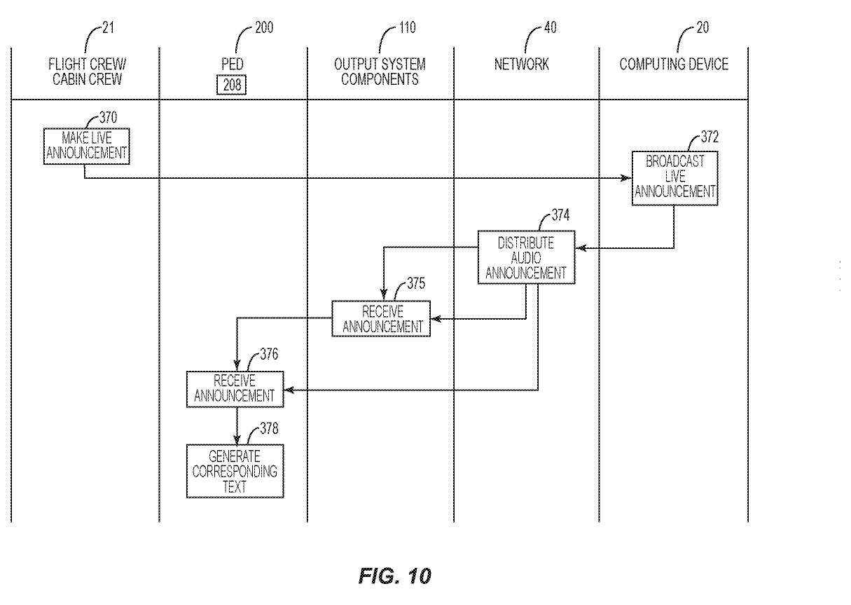

FIG. 10 illustrates an example in which the PED 200 is equipped with an app 208 configured to process the audio content and generate the text content. The app 208 is loaded onto the PED 200 at an earlier time, such as but not limited to when purchasing a ticket, boarding the flight, or during pre-flight preparation. In some examples, the instructions on how to download the app are provided to passengers through the display 110 at their seat 103.

In the example of FIG. 10, a live announcement is made during the flight (block 370). The live audio is processed by the computing device 20 (block 372) which distributes the audio through the network 40 (block 374). The audio content is played through one or more speakers 110 of the output system (block 374) and is received by the PED 200 (block 376). The PED 200 is then able to process the audio content and generate the corresponding text (block 378). The corresponding text is displayed on the display screen of the PED 200. Additionally, or alternatively, the PED 200 transmits the corresponding text to the display system for display on its one or more display screens 110.

In some examples, the audio content is distributed through the network 40 directly to the PED 200 without playing on a speaker 110 of the output system. The PED 200 receives the content and generates the corresponding text which is then displayed on the PED 200 and/or one or more displays 110.

In the example above, the corresponding text is generated for live announcements. In some examples, the PED 200 also generates corresponding text for pre-recorded announcements. The process occurs in a similar manner in which the PED 200 receives through its microphone the audio content that is made in the cabin area 102. The PED 200 then generates the corresponding text for display to the passenger. An advantage of the PED 200 processing the pre-recorded announcements is the corresponding text is not stored at the attendant panel 30. This saves storage space and processing requirements, particularly since the corresponding text for multiple different languages may be saved for each pre-recorded announcement. Further, the PED 200 includes the language selection of the user and is able to generate the corresponding text in the applicable language for the passenger.

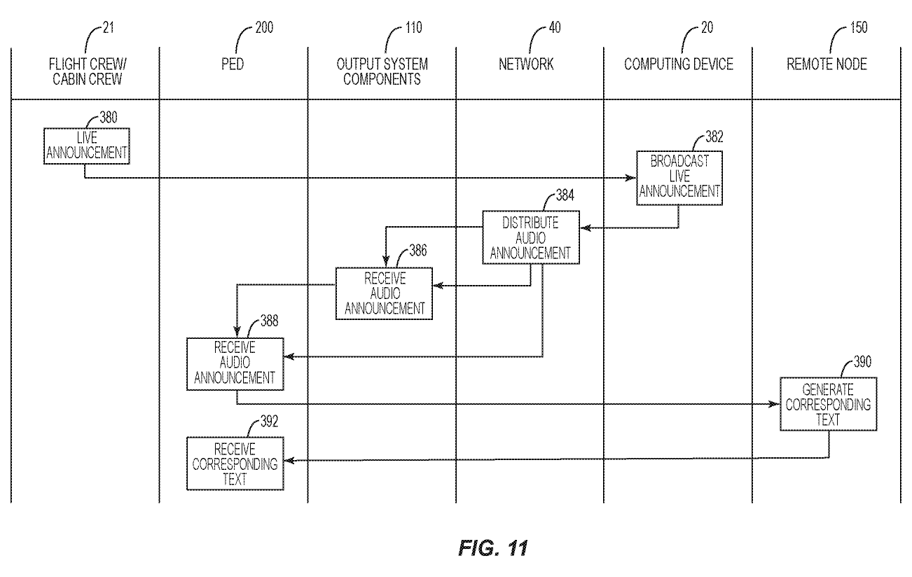

In some examples as illustrated in FIG. 11, the PED 200 captures the audio content played in the cabin area 102 and transmits the audio content for offboard processing. The live announcement is made through one or more microphones 21 (block 380). The audio content is received by the computing device 20 (block 382). The audio content is distributed through the network 40 to play through the speakers 110 of the output system (block 386). In some examples, the PED 200 captures the audio from the speakers 110 of the output system (block 388). Additionally, or alternatively, the PED 200 receives the audio content from the computing device 20 via the network 40. The PED 200 transmits the audio content offboard the aircraft 100 to the remote node 150. The remote node 150 generates the corresponding text (block 390) and transmits the corresponding text to the PED 200 (block 392). The PED 200 is then able to display the corresponding text through a display screen on the PED 200. In some examples, the PED 200 sends the corresponding text to the output system to be displayed on its display screen 110.

In some examples, the audio content that is entered through the attendant panel 30 is played through the speakers 110 of the output system 110 and the PED 200. In other examples, one or more of the audio content is just displayed as text content on the display devices 110 and PED 200 without being played through any of the speakers 110 or PED speakers. In some examples, this includes non-critical information that occurs during flight. Examples include but are not limited to the start of meal service or a reminder to keep the aisles clear. Broadcasting the content just as text content on the display devices enables communicating information in a manner without disturbing the passengers, such as passengers that are sleeping.

The audio content that is not broadcast over the speakers can vary. In some examples, the cabin crew enters an input at the attendant panel 30 to indicate to the computing device 20 how the audio content is to be broadcast. In another example, all pre-recorded content is just displayed on the display devices and not played as audio through the speakers. In some examples, live announcements made through the one or more microphones 21 are generally considered more important and presented both as text content on the display devices 110 and audio content through the speakers 110 as well as the PED 200.

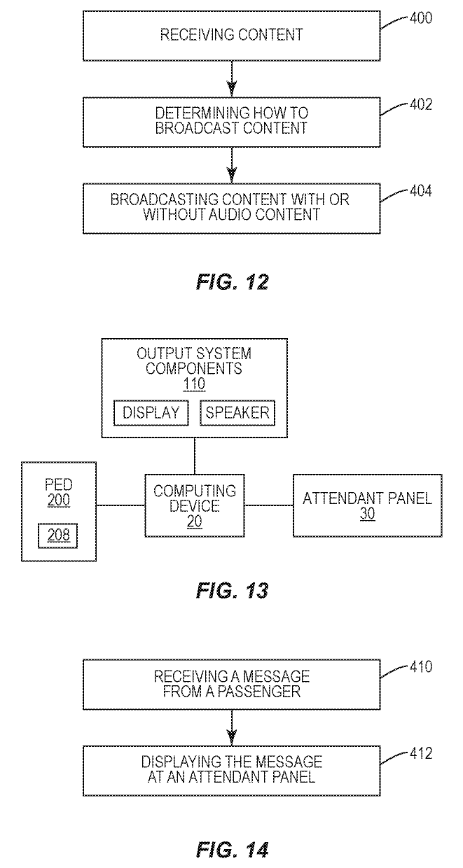

FIG. 12 illustrates a method of presenting content to passengers in an aircraft 100. The content is received by the computing device 20 (block 400). The computing device 20 determines how to broadcast the content (block 402). The computing device 20 then broadcasts the content accordingly either with or without audio content through the speakers (block 404).

In some examples, the content is received through the attendant panel 30. In other examples, the content is received from a crew device, such as a PED 200 that is operated by one of the flight personnel.

In some examples, the computing device 20 is configured to receive text messages from a passenger. This enables two-way “attendant-call” text messaging for the passenger to provide more context regarding their need. This further enables a more private and discrete way for passengers to indicate that help is needed with a sensitive issue.

FIG. 13 illustrates a passenger PED 200 configured for communication with the computing device 20. In some examples, this functionality is provided through use of the app 208 that is downloaded and stored. In other examples, the functionality is provided through a different app and/or through the general text messaging functionality of the PED 200. In some examples, instructions are provided to passengers regarding how to communicate via text messages with the computing device 20. For example, instructions are provided as part of the pre-flight process or otherwise made available to the passenger during the flight.

The PED 200 is configured to communicate by one or more messaging applications with the computing device 20. In some examples, the communication is limited to providing answers to predetermined questions (e.g., “Do you need assistance with the lavatory?”). In other examples, the communications are not bounded and are input by the user typing their need. The computing device 20 transmits the communication for display on a display device associated with the attendant panel 30. This enables flight personnel to be aware of the issue. The flight personnel are able to use an input device (e.g., keyboard, display screen) at the attendant panel 30 to respond back to and communicate with the passenger.

The communication can occur through one or more messaging applications. Examples include but are not limited to short message service (SMS), multimedia messaging service (MMS), Instant messaging (e.g., WhatsApp, FACEBOOK Messenger), various application services (e.g., iMessage) and rich communication services (RCS).

FIG. 14 illustrates a method of communicating with a passenger on an aircraft 100. The method includes receiving a message from a passenger through their PED 200 (block 400). The content of the message is displayed on a display device at the attendant panel 30 (block 412).

The two-way texting process provides for more specific information to be provided to the cabin crew prior to checking in on the passenger. Further, this process enables the passenger to discretely enter sensitive information that they may want to be kept secret from other passengers.

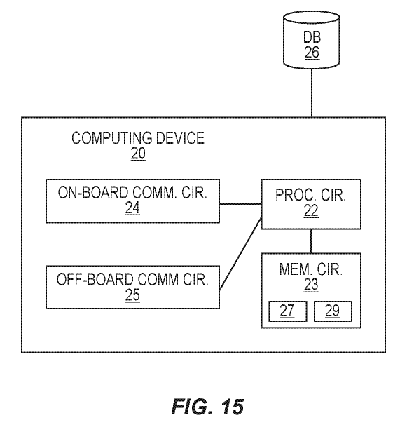

FIG. 15 illustrates a computing device 20 that performs the various functions disclosed above. In some examples, the computing device 20 is a stand-alone component. In other examples, the computing device 20 is incorporated into one or more other computing devices on the aircraft 100 such as but not limited to an entertainment system, and larger flight and aircraft control systems.

The computing device 20 can include one or more of each of a number of components such as, for example, processing circuitry 22 (e.g., processor unit) connected to a memory circuitry 23 (e.g., storage device). The processing circuitry 22 may be composed of one or more processors alone or in combination with one or more memories. The processing circuitry 22 is generally computer hardware that is capable of processing information such as, for example, data, computer programs and/or other suitable electronic information. The processing circuitry 22 is composed of a collection of electronic circuits some of which may be packaged as an integrated circuit or multiple interconnected integrated circuits (an integrated circuit at times more commonly referred to as a "chip"). The processing circuitry 22 may be configured to execute computer programs 29 with programming instructions which may be stored onboard the processing circuitry 22 or otherwise stored in the memory circuitry 23 (of the same or another device).

The processing circuitry 22 may be a number of processors, a multi-core processor or some other type of processor, depending on the particular implementation. Further, the processing circuitry 22 may be implemented using a number of heterogeneous processor systems in which a main processor is present with one or more secondary processors on a single chip. As another illustrative example, the processing circuitry 22 may be a symmetric multi-processor system containing multiple processors of the same type. In yet another example, the processing circuitry 22 may be embodied as or otherwise include one or more ASICs, FPGAs or the like. Thus, although the processing circuitry 22 may be capable of executing a computer program to perform one or more functions, the processing circuitry 22 of various examples may be capable of performing one or more functions without the aid of a computer program. In either instance, the processing circuitry 22 may be appropriately programmed to perform functions or operations according to example implementations of the present disclosure.

The memory circuitry 23 is generally computer hardware that is capable of storing information such as, for example, data, computer programs (e.g., computer-readable program code) and/or other suitable information either on a temporary basis and/or a permanent basis. The memory circuitry 23 may include volatile and/or non-volatile memory and may be fixed or removable. Examples of suitable memory circuitry 23 include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory circuitry 23 may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

The speech-to-text modules (see FIG. 5) are stored at the computing device 20 to enable the processing circuitry 22 to generate the corresponding text of live audio.

As will be appreciated by those of ordinary skill in the art without undue experimentation, program code instructions 29 may be loaded onto the computing device 20 or other programmable apparatus from a computer-readable storage medium to produce a particular machine, such that the particular machine becomes a means for implementing the functions specified herein. These program code instructions 29 may also be stored in a computer-readable storage medium that can direct a computer, a processing circuitry or other programmable apparatus to function in a particular manner to thereby generate a particular machine or particular article of manufacture. The program code instructions 29 may be retrieved from a computer-readable storage medium and loaded into a computer, processing circuitry or other programmable apparatus to configure the computing device 20, processing circuitry 22 or other programmable apparatus to execute operations to be performed on or by the computer, processing circuitry or other programmable apparatus.

Computing device 20 also includes onboard communications circuitry 24 configured to transmit and/or receive information from one or more components that are positioned on the aircraft 100 directly and/or through the network 40. Offboard communication circuitry 25 provides for communicating with the remote node 150. The offboard communication can occur through one or more known protocols. Examples include but are not limited to communications through a mobile communication network (e.g., a WCDMA, LTE, or WiMAX network), a Wireless Local Area Network (WLAN) 75 that operates according to the 802.11 family of standards, and through one or more satellites 76.

A database 26 is configured to store data used by the processing circuitry 22. In some examples, the database 26 stores one or more of the pre-recorded content, corresponding text, machine learning model 27 to perform the speech-to-text functionality, and programming instructions 29.

In some examples, the computing device 20 includes a machine learning (ML) model 27. The computing device 20 is configured to train the machine learning model 27 using historical data of previously captured audio content that is input through the microphone 21 (e.g., training data) as well as other content data. This training enables the machine learning model 27 to be applied to the current content data to provide a more accurate process of generating text content from audio content. In some examples, the training data uses aircraft-specific language to train the model 27 to identify aviation terminology that will be regularly encountered.

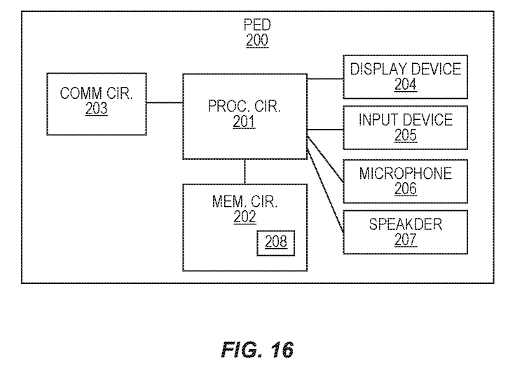

FIG. 16 illustrates components of the PED 200. The PED is a compact, battery-powered, and easily transportable device used for various functions including but not limited to data storage, recording, and wireless communication. The PED 200 includes one or more of each of a number of components such as, for example, processing circuitry 201 (e.g., processor unit) connected to a memory circuitry 202 (e.g., storage device). In some examples, the processing circuitry 201 is composed of one or more processors alone or in combination with one or more memories. The processing circuitry 201 is generally computer hardware that is capable of processing information such as, for example, data, computer programs and/or other suitable electronic information. The processing circuitry 201 is composed of a collection of electronic circuits some of which may be packaged as an integrated circuit or multiple interconnected integrated circuits (an integrated circuit at times more commonly referred to as a "chip"). The processing circuitry 201 may be configured to execute the text processing app 208 which may be stored onboard the processing circuitry 201 or otherwise stored in the memory circuitry 202.

The memory circuitry 202 is generally computer hardware that is capable of storing information such as, for example, data, apps, computer programs (e.g., computer-readable program code) and/or other suitable information either on a temporary basis and/or a permanent basis. The memory circuitry 202 may include volatile and/or non-volatile memory and may be fixed or removable. Examples of suitable memory circuitry 202 include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory circuitry 52 may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

The PED 200 also includes communications circuitry 203 configured to transmit and/or receive information from one or more components that are positioned on the aircraft 100 directly and/or through the network 40. In some examples, the communications circuitry 203 provides for accessing the network 40 through a wireless node. The communication circuitry 203 is further configured for offboard communications with the remote node 150. The offboard communication can occur through one or more known protocols. Examples include but are not limited to communications through a mobile communication network (e.g., a WCDMA, LTE, or WiMAX network), a Wireless Local Area Network (WLAN) 75 that operates according to the 802.11 family of standards, and through one or more satellites 76.

The PED 200 also includes a display device 204 for visually displaying information such as but not limited to the corresponding text that is displayed with the live audio. An input device (e.g., keypad) enables the passenger to enter commands to operate the PED 200. The PED 200 also includes a microphone 206 and speaker 207.

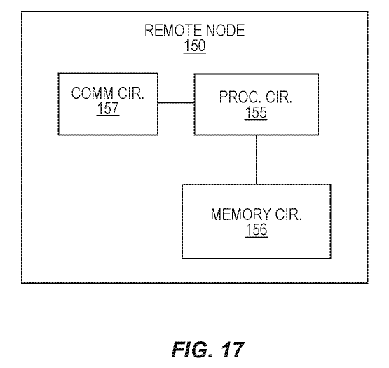

As illustrated in FIG. 17, the remote node 150 includes one or more processing circuits (shown as processing circuitry 155) that may include one or more microprocessors, microcontrollers, Application Specific Integrated Circuits (ASICs), or the like, configured with appropriate software and/or firmware. A computer readable storage medium (shown as memory circuitry 156) stores data and computer readable program code that configures the processing circuitry 155 to implement the techniques described above. Memory circuitry 156 is a non-transitory computer readable medium and may include various memory devices such as random access memory, read-only memory, and flash memory. Communications circuitry 157 is configured to communication with the aircraft 100 and with the PED 200 according to various communications standards.

The attendant panel 30 includes processing capability to perform various functions to provide content to the passengers. In some examples, the attendant panel 30 includes processing circuitry, memory circuitry, and communication circuitry similar to the computing device 20 to perform this functionality. In some examples, the attendant panel 30 is the computing device 20 and performs this functionality.

In some examples, the system 19 is configured to enable text-to-text language translation. The passenger is able to translate the text content in a first language to a second language.

The systems and functions disclosed herein are applicable for use in a variety of different vehicles. One example as disclosed above is for use on an aircraft. Other examples include use with vehicles including but are not limited to trucks, cars, trains, buses, and ships.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of displaying text of a live audio announcement to a passenger on a vehicle, the method comprising:
receiving audio content of a live audio announcement that is presented by personnel that are onboard the vehicle;
converting the audio content to text content that corresponds to the audio content;
playing the audio content onboard the vehicle through a speaker to the passenger; and
displaying the text content onboard the vehicle on a display device to the passenger.

2. The method of claim 1, further comprising receiving the audio content through a microphone onboard the vehicle.

3. The method of claim 1, further comprising simultaneously playing the audio content through the speaker and displaying the text content on the display device.

4. The method of claim 1, further comprising converting the audio content to the text content onboard the vehicle.

5. The method of claim 1, further comprising:
transmitting the audio content to a remote node offboard of the vehicle;
receiving onboard the vehicle the text content from the remote node; and
displaying onboard the vehicle the text content that is received from the remote node.

6. The method of claim 1, wherein converting the audio content to the text content comprises translating the audio content from a first language to the text content in one or more other languages.

7. The method of claim 1, wherein converting the audio content to the text content comprises formatting the text content to a predetermined format to enable being displayed on the display device.

8. The method of claim 1, further comprising processing the audio content with a computing device onboard the vehicle and playing the audio content through the speaker and converting the audio content to the text content on a portable electronic device of the passenger.

9. The method of claim 1, further comprising:
receiving the audio content at a portable electronic device of the passenger;
transmitting the audio content from the portable electronic device to a remote node offboard the vehicle; and
after transmitting the audio content, receiving the text content at the portable electronic device from the remote node.

10. A method of displaying text of a live audio announcement to a passenger on a vehicle, the method comprising:
receiving at a computing device onboard the vehicle audio content that is input through a microphone that is onboard the vehicle;
presenting the audio content to the passenger onboard the vehicle;
generating text content that corresponds to the audio content; and
displaying the text content on a display device onboard the vehicle to the passenger.

11. The method of claim 10, wherein presenting the audio content comprises transmitting the audio content to a portable electronic device and playing the audio content through a speaker of the portable electronic device.

12. The method of claim 10, wherein generating the text content comprises generating the text content onboard the vehicle.

13. The method of claim 12, wherein generating the text content comprises generating the text content at a portable electronic device of the passenger.

14. The method of claim 13, wherein generating the text content occurs offboard the vehicle.

15. The method of claim 14, further comprising transmitting the audio content from a portable electronic device of the passenger to a remote node that is offboard the vehicle with the remote node generating the text content.

16. The method of claim 15, further comprising receiving a registration request for the portable electronic device prior to transmitting the audio content.

17. The method of claim 10, further comprising delaying presenting the audio content and simultaneously displaying the audio content and the text content.

18. A computing device to display content on a vehicle, the computing device comprising:
processing circuitry; and
memory circuitry that stores programming instructions that, when executed by the processing circuitry, configures the computing device to:
receive audio content that is presented by personnel that are onboard the vehicle;
convert the audio content to text content that corresponds to the audio content; and
display the text content on a display device to the passenger.

19. The computing device of claim 18, further comprising communication circuitry configured to transmit the audio content to a remote node offboard the vehicle and receive the text content from the remote node.

20. The computing device of claim 18, wherein the processing circuitry and the memory circuitry are located on the vehicle.
